(19) United States
(12) Patent Application Publication
(10) Pub. No.: US 2023/0213552 A1
(43) Pub. Date: Jul. 6, 2023

(54) A PROBE CASSETTE FOR STORING, TRANSPORTING AND HANDLING ONE OR MORE PROBE DEVICES FOR A PROBE BASED SYSTEM

(71) Applicant: Nearfield Instruments B.V., Rotterdam (NL)

(72) Inventors: Johannes Gradus Martinus KOERS, Rotterdam (NL); Servaas Louis BANK, Enschede (NL); Hamed SADEGHIAN MARNANI, Rotterdam (NL); Artem KHACHATURIANTS, Rotterdam (NL); Arseniy KALININ, Rotterdam (NL)

(21) Appl. No.: 17/928,190

(22) PCT Filed: May 28, 2021
(86) PCT No.: PCT/NL2021/050340

§ 371 Date: Nov. 28, 2022

(30) Foreign Application Priority Data
May 29, 2020 (NL) 2025703

(51) Int. Cl. G01Q 70/02; G01Q 60/38

(52) U.S. Cl. CPC G01Q 70/02; G01Q 60/38

(57) ABSTRACT

The invention relates to a probe cassette for storing, transporting and handling one or more probe devices for a probe based system, the cassette including: a cassette body having at least one probe receptacle arranged to accommodate a probe device, a lid connectable to the cassette body, and a clamping unit configured to retain the probe device at the receptacle by exerting a clamping force on said probe device when the lid is in a closed position, wherein the clamping unit includes an adjustment member for adjusting the clamping force, wherein the clamping unit is selectively operable from a first position, in which the clamping force is insufficient to provide clamping, to a plurality of second positions, in which the clamping force is sufficient to an extent at which movement of the probe device at the receptacle is prevented.

### FIELD OF THE INVENTION

The invention relates to a probe cassette for storing, transporting and handling one or more probe devices for a probe based system, such as an scanning probe microscope. The invention further relates to a method of storing, transporting and handling one or more probe devices for a probe based system. Furthermore, the invention relates to the use of the probe cassette.

### BACKGROUND TO THE INVENTION

Probe-based systems such as scanning probe microscopes are widely used for characterizing properties of a sample by the interaction between a probe device and a sample. The probe device can be mounted in a scanning probe microscope (e.g. atomic force microscope). Different types of probe devices exist. Commonly, cantilever-based probe devices are employed. Such cantilever-based probe devices may have a tip to make a local measurement of one or more properties of the sample. Probe based systems can characterize small-scale sample features by monitoring the interaction between the sample and the tip of the associated probe device. Surface characterization, subsurface characterization, and/or other sample-dependent data can be determined over a particular region of the sample by providing a relative scanning movement between the tip and the associated probe device. Additionally or alternatively, the probe device may also be used for modifying the surface of the sample using the probe based system.

Probe devices used in scanning probe microscopy typically have very small dimensions and tend to require delicate handling. It is known to place one or more probe devices in a probe cassette for delivery to the user or customer in order to facilitate transport and prevent damage to the probe devices. The probe cassette may be container or holder including holding elements arranged for rigidly keeping the probe devices substantially in position even when transporting the cassette (e.g. shipment, on-site transport, handling, etc.). The probe devices may also be positioned in a gel box, having a gel for holding the probe devices in place.

A lid may be placed on top of the body of the cassette when the probe devices are loaded onto a body of the cassette. The lid may cover the probe devices when closed. Furthermore, the lid may be arranged to facilitate securing of the probe devices to the cassette for instance by using probe device retainers mounted on the underside of the lid.

Publication US 7,908,909 B2 describes a probe cassette for holding one or more probe devices of a scanning probe microscope. The probe cassette includes a base having at least one probe storage receptacle; a lid mountable on the base so as to at least substantially cover the at least one receptacle; a probe retainer that retains at least one of the SPM probe devices in the receptacle under a compressive force; and wherein the compressive force is generated by deforming a spring.

Existing probe cassettes may not provide an adequate clamping. The mechanical clamping provided by such a lid or cover, may not be sufficient. The cassette may not be able to absorb impact for preventing damage to the probe devices. Furthermore, the probe devices may displace as a result of such impact or vibrations, e.g. during transportation or handling of the probe cassette.

When closing the lid or cover, a retainer arranged on or connected to said lid can damage the probe device. Typically, the clamping in too sensitive for engineering tolerance. Furthermore, the mechanical clamping mechanisms are available only for specific probe device body thickness, whereas thickness can variate depending on the probe device manufacturer.

There is a need for improving the clamping used in probe cassettes.

### SUMMARY OF THE INVENTION

It is an object of the invention to provide for a method and a system that obviates at least one of the above mentioned drawbacks.

Additionally or alternatively, it is an object of the invention to provide for an improved clamping mechanism for a cassette.

Additionally or alternatively, it is an object of the invention to reduce the risk of damage to probe devices during transportation or handling.

Thereto, the invention provides for a probe cassette for storing, transporting and handling one or more probe devices for a probe based system, the cassette including: a cassette body having at least one probe receptacle arranged to accommodate a probe device, a lid connectable to the cassette body, the lid in a closed position being configured to substantially cover the at least one receptacle, and a clamping unit configured to retain the probe device at the receptacle by exerting a clamping force on said probe device, wherein the clamping unit includes an adjustment member for adjusting the clamping force, wherein the clamping unit is selectively operable from a first position, in which the clamping force is insufficient to provide clamping of the probe device at the receptacle, to a plurality of second positions, in which the clamping force restricts movement of the probe device at the receptacle, the plurality of second positions providing different clamping forces for restricting the probe device to a different extent.

Instead of using a spring-based or material stiffness based clamping force exerted on the probe devices when the lid is closed, the clamping unit provides multiple selectable positions resulting in different clamping forces. In this way, an adjustable clamping force can be provided by means of the clamping unit. The clamping of the probe devices can be improved, furthermore the clamping force can be chosen depending on dynamic conditions (e.g. transportation, handling, storage) requiring a different clamping force. The clamping unit is adapted to generate a non-material stiffness based clamping force on the probe devices when the lid is in the closed position. An improved control over the clamping force can be obtained as the clamping unit includes a plurality of second positions each having different pre-determined clamping forces for the probe devices positioned at the receptacles. Hence, the clamping can be improved, reducing the risk of damaging the one or more probe devices during storing, transport and/or handling.

The plurality of second positions of the clamping unit provide adjustability of the clamping force. The clamping force can be accurately controlled, for instance depending on the activity, e.g. storage, handling, transportation of the probe cassette. In some examples, the clamping force can also be measured and/or logged.

Optionally, in the plurality of second positions, the clamping force is sufficient for preventing movement of the probe device at the receptacle.

A clamping force can be selectively imparted on the probe device by means of the clamping unit for retaining the probe devices in the probe cassette. The adjustable clamping unit may provide for a precise clamping mechanism not so much dependent on structure interaction with a structural element for holding the probe devices at the receptacles. For example, mechanical retainers based on elasticity or springs may more easily deform, damage, change stiffness in time, or scrape the probe devices. Moreover, such elasticity-based mechanical retainers may change stiffness in time, for instance reducing the effectivity of the clamping. Such damage can be prevented by using an adjustable clamping unit.

Optionally, the one or more probe devices are loadable back to the cassette after usage.

The lid can be movably connected to the cassette body, for instance by means of a hinge mechanism. The lid can be displaceable between an opened position and a closed position. In the opened position of the lid, the one or more probe devices at the receptacles are accessible. For instance, the cassette may be opened prior to moving it to a probe based system such as an atomic force microscope. The atomic force microscope can thereby access at least one of the probe devices carried by the probe cassette. In the closed position of the lid, the one or more probe devices are covered by said lid. The clamping unit can be configured to provide clamping of the one or more probe devices at least when the lid is closed. In this way, for instance during handling or transportation, it can be substantially prevented that the probe devices are displaced within the cassette, which could result in damage.

Optionally, the lid in a closed position is adapted to retain the one or more probe devices at the respective receptacles on the body of the probe cassette. The lid may include he clamping unit which is configured to generate a non-material stiffness/elasticity based clamping force on the probe devices when the lid is in the closed position. Advantageously, the clamping force generated using the clamping unit is adaptable and/or adjustable. In this way, the arrangement can become less dependent on tolerances. Moreover, the cassette may be adapted to work with different types of probe devices, for instance having different dimensions. Hence, the probe compatibility of the probe cassette can be enhanced.

Optionally, the probe cassette is adapted to hold one or more first probe devices and/or one or more second probe devices, the one or more first probe devices and the one or more second probe devices having different dimensions and/or shapes.

Optionally, the clamping unit is arranged such that the camping force is exerted on said probe device exclusively when the lid is in the closed position.

Optionally, the clamping unit comprises an actuator which is selectively actuatable from the first position to one of the plurality of the second positions.

The probe cassette can have an actuator arrangement for providing selective clamping, wherein the induced clamping force is adjustable by controlling said actuator. Various types of actuators can be used.

The actuator may provide actuation upon actuation. The cassette may be configured such that the clamping unit can be brought in the plurality of second positions when the lid is provided onto the cassette body.

Optionally, the clamping unit includes an electromechanical actuator which is configured to selectively provide the clamping force.

The electromechanical actuator can be electrically actuated for providing a mechanical clamping. By adjusting the electrical actuation, an adjustment of the mechanical clamping force can be obtained.

Optionally, the electromechanical actuator is a piezoelectric actuator. The piezoelectric actuator can have different configurations. For instance, the piezoelectric actuator may be configured to be switchable between an elongated position and a contracted position. Additionally or alternatively, the piezoelectric actuator may be arranged to bend causing a displacement usable for obtaining the clamping force. A larger deflection can be obtained in this way at the tip of the piezoelectric actuator. Additionally or alternatively, the piezoelectric actuator may be operated in shear mode for obtaining a shear displacement.

Optionally, the electromechanical actuator is an elastomer actuator.

The piezoelectric actuator and the elastomer actuator can provide accurate control over the clamping force. It will be appreciated that other electromechanical actuators may also be used, such as for instance an electromotor.

Optionally, the clamping unit includes a capillary tube which is configured to guide a liquid towards a surface of the probe device at the receptacle when the lid is in the closed position, wherein the clamping unit is configured to provide the clamping force from a resulting surface tension of the liquid.

The capillary tube can be configured to provide a drop of liquid between its outlet and the probe device at the receptacle. The resulting clamping force obtained by means of the drop of liquid can be dependent on a gap distance between the outlet of the capillary tube and the probe device. This distance may be adjustable in order to enable adjustment of the clamping force. Additionally or alternatively, the clamping force is adjusted by changing the amount of liquid guided through the capillary tube.

Optionally, the clamping unit includes one or more magnets for providing the clamping force.

It is possible to use electromagnets, static magnets, or a combination thereof. For instance, the static magnets may be arranged such that when the lid is closed, the like poles of the magnets approach each other inducing the required clamping force for retaining the probe devices in position. The like poles repel each other, and by changing a gap distance therebetween in the closed position of the lid, the clamping force can be adjusted. Hence, the clamping force can be achieved as a result of interaction between like magnetic poles.

Optionally, at least one electromagnet is used. In this way, the clamping force can be more easily adjusted by changing the magnetic field generated by the electromagnet. Various types of solenoids can be used for achieving the clamping force.

The clamping unit at a receptacle may include two magnets arranged to face each other. The relative position of at least one of the two magnets in the probe cassette may be adjustable with respect to each other, such that the resulting clamping force can be adjusted.

It is also envisaged to use two permanent magnets and at least one electromagnet. For example, a first permanent magnet can be coupled to a further electromagnet to overlay the magnetic field generated between the two permanent magnets. A controller or control unit can be linked to the electromagnet such as to vary the magnetic field and adjust the resulting clamping force. Optionally, a sensor is arranged for monitoring changes in a gap distance between the facing like magnet poles (N, N, or S, S) to activate the electromagnet for a stronger magnetic field to adjust the resulting clamping force. Other sensors can also be employed for estimating or monitoring the resulting generated clamping force.

Optionally, the clamping unit includes a membrane expandable under fluid pressure, wherein the membrane in an expanded position contacts the probe device at the receptacle for providing the clamping force. The membrane can push against a surface of the probe device when in expanded position. As a result of the pushing action, a clamping force is obtained. The clamping force can be adjusted by changing the fluid pressure applied on the membrane.

Optionally, the membrane forms an stretchable balloon arranged proximate the probe device when the lid is in the closed position. The expandable balloon may provide an improved control over the induced clamping force exerted on the probe device.

Optionally, the clamping unit includes a fluid blower which is configured to blow a flow of fluid towards the probe device for providing the clamping force.

The fluid flow may provide a pushing action on the probe device holding it in position at the receptacle. The fluid flow achieved by the fluid blower results in a clamping force exerted on the probe device at the receptacle. The applied pressure or clamping force resulting from the flow of fluid provided by the fluid blower can be adjusted by changing the flow which is directed towards the probe device (parameters are e.g. flow rate, flow direction, fluid pressure, etc.).

Optionally, the clamping unit includes a vacuum clamping member which is arranged for selectively holding the probe device under clamping force, wherein at the receptacle at least one aperture is arranged, which is, during selective holding of the probe device, connectable to a vacuum pressure through a passageway arranged in the cassette body.

Optionally, the clamping force is a tensile retaining force and/or a suction force.

Optionally, the clamping unit is a first clamping unit, and wherein the probe cassette includes a further second clamping unit, different from the first clamping unit, wherein the first clamping unit is operable from the first position to one of the plurality of second positions if the lid is closed, wherein the second clamping unit is arranged at the cassette body for selectively holding the probe device at the receptacle under a clamping force, wherein the second clamping unit is adjustable between a first state, in which the tensile retaining force is sufficiently large such as to enable clamping of the probe device, and a second state, in which the tensile retaining force is sufficiently small such as to allow release of the probe device, wherein the second clamping unit is operable when the lid is in an opened position in which the one or more probe devices accommodated in the probe cassette are accessible.

Optionally, the second clamping unit provides clamping by means of vacuum pressure. Such a vacuum clamping member can be arranged for selectively holding the probe device under a clamping force. At the receptacle at least one aperture can be arranged, which is, during selective holding of the probe device, connectable to a vacuum pressure through a passageway arranged in the cassette body, wherein the cassette includes a first fluid port connectable to a first source of vacuum for delivering the vacuum pressure.

It will be appreciated that vacuum can be understood as a underpressure resulting in a clamping force (e.g. suction force). Different underpressures or vacuum pressures can be used for achieving a clamping retaining force. The clamping can be improved by providing a sealing member at the interface between the clamping unit and the probe device.

Vacuum communicated to the vacuum clamping member may cause the probe device to be firmly held to the body of the cassette at the receptacle by the differential pressure acting on the probe device. An improved vacuum-based clamping mechanism is obtained for retaining the probe device in place on the body of the cassette. The chance that the integrity of the probe devices is compromised during handling, transportation, loading, mounting, etc. of the cassette can be reduced. The vacuum may generate a suction force applied to the probe device. This induced tensile force can be sufficiently large for effectively fixating the probe device onto the body of the cassette. The vacuum clamping member can provide a reliable clamping mechanism requiring limited maintenance.

The vacuum clamping member can retain the probe device onto the body of the cassette without needing mechanical retaining means, for instance such as a lid arranged for covering and retaining the probe devices when the lid is closed. Hence, a clamping mechanism may be provided even if mechanical retaining means (e.g. lid) are removed (e.g. lid opened or removed). Furthermore, displacement of the probe devices carried by the probe cassette can be minimized, reducing the risk of potential damage to the probe devices as a result handling, transportation and/or loading in the probe based system (e.g. scanning probe microscope such as an atomic force microscope).

The vacuum clamping member provides a vacuum retaining mechanism which is more easily controlled, more accurate, more robust and/or less sensitive to the tolerances on dimensions with respect to other retainers configured for contacting and holding probe devices at one or more points (e.g. kinematic retainers). Additionally or alternatively, the vacuum retaining mechanism may enable easy alignment of the probe devices on the body of the cassette.

Optionally, the first fluid port is connectable to the first source of vacuum through a corresponding flexible tube. A non-flexible tube may also be used.

Optionally, the probe cassette includes a second fluid port connectable to a second source of vacuum.

The second fluid port may be different from the first fluid port. In this way, the cassette may be connected to different sources of vacuum. For instance, the cassette may be displaced and subsequently inserted in a probe based system with a first source of vacuum providing vacuum pressure to the vacuum clamping members. The cassette inserted in the probe based system may be connected to a second source of vacuum (e.g. machine vacuum pressure provided by the probe based system). The first fluid port may be disconnected, such that the cassette solely obtains vacuum pressure from the second source of vacuum. It is also envisaged that the first fluid port and the second fluid port are the same.

The probe cassette may include means for temporarily connecting a vacuum source thereto (e.g. through the first fluid port). Optionally, the cassette further includes means for automatically connecting to the second source of vacuum (machine vacuum) when the cassette is received in the probe based system. The first fluid port may be used for (temporarily) providing vacuum during handling and transfer of the cassette to the probe based system, and the second fluid port may be used for providing a machine vacuum as applied in the probe based system. In both cases, the same vacuum members may be used for fixating the probe devices in place using the induced tensile retaining force as a result of the vacuum.

Optionally, the vacuum clamping member is adjustable between a first position, in which the vacuum pressure is sufficiently low for enabling vacuum clamping of the probe device, and a second position, in which the vacuum pressure is sufficiently high for allowing release of the probe device.

The probe device may be releasable by controlling a vacuum pressure provided to the vacuum clamping member. The pressure provided to the vacuum clamping member may be switched between at least two states, namely a vacuum clamping state and a non-clamping state. In the vacuum clamping state, vacuum pressure is provided to the vacuum clamping member for keeping the probe device in place on the body of the cassette. In the non-clamping state, no vacuum pressure is provided to the vacuum clamping member, enabling release of the probe device from the body of the cassette if the probe device is not retained by other means (e.g. form locked by a lid).

Optionally, the first clamping unit is arranged at the lid of the cassette probe, and wherein the first clamping unit is automatically operated in one of the plurality of second positions if the lid is brought in the closed position.

Optionally, the cassette including a controller arranged for controlling the clamping unit for adjusting the clamping force exerted by the clamping unit.

Optionally, the cassette is arranged to be receivable in a probe device delivery package including a package base and a package lid connectable with each other, wherein the package lid is mountable over the body of the cassette so as to substantially cover the at least one receptacle, wherein at least one of the package lid or the body includes means arranged to retain the one or more probe devices on the body of the cassette, wherein the first fluid port is connectable to the first source of vacuum with the package lid in a closed position.

The lid may facilitate retaining the at least one probe device on the base of the cassette . Once the suction force induced by the vacuum clamping member is generated, the lid can be removed and the probe devices can be automatically loaded onto a probe mount of the probe based system (e.g. scanning probe microscope). It will be appreciated that the suction force can be exerted selectively before and/or after opening/removing the lid.

It will be appreciated that instead of providing a probe cassette receivable/mountable in a probe device delivery package, a cassette may be provided including a lid and a base, wherein in a closed state of the lid, the one or more probe devices positioned on the body of the cassette are covered by the lid.

Advantageously, it can be prevented that the probe devices can move with respect to the cassette or the lid, when the lid is closed or open or being opened or being closed or when the cassette is placed in/out the machine or during handling. Particle contamination can also be prevented.

Optionally, the cassette includes a controller, wherein the controller is configured to adjust the tensile retaining force exerted by means of the vacuum clamping member by controlling the vacuum pressure.

Optionally, the vacuum clamping member has at least one connection portion arranged to conform to a surface of the at least one probe device so as to form a sealing contact therewith. The body of the cassette at the receptacle may be arranged to have a complementary shape to a probe shape.

The receptacle may be adapted to form a seat for the probe device, wherein the probe device received in the seat is supported in a position allowing the connection portion of the vacuum clamping member to vacuum hold the probe device in position. Such a seat may for instance be formed by an indentation, a lowered plane, an inclined surface, etc. on the body of the cassette. The seat may optionally be arranged to provide form lock in at least one dimension, preferably at least two dimensions. Optionally, the receptacle has an inclined surface for facilitating seating of the probe device thereon.

Optionally, a plurality of apertures are arranged at the receptacle for vacuum retaining the probe device onto the body of the cassette during selective holding of the at least one probe device. In this way, the forces may be more evenly distributed over a surface of the probe device, allowing for an improved vacuum clamping.

Optionally, the vacuum clamping member includes a seal configured to provide a sealing interface with the probe device in order to substantially prevent leakage of gas.

In this way, a lower vacuum pressure can be maintained upon the probe device for holding the probe device fixed at the receptacle. The sealing may allow a precise control over the obtained tensile force. Many types of seals can be used. The seal may also be formed by a portion of the body of the cassette (form seal). Additionally or alternatively, an elastic or rubber seal can be arranged for obtaining conformal sealing between a portion of the probe device (e.g. lower surface) and the body of the cassette. In an example, the vacuum clamping members include suction cups.

Optionally, the cassette includes a plurality of receptacles arranged in at least one array. The cassette may include a plurality of arrays. In this way, a large number of probe devices may be carried by means of the cassette. Each receptacle may receive at least one probe device.

Optionally, the body of the cassette includes several arrays/rows of probe device receptacles or pockets designed to accommodate probe devices of one or more types. The probe devices may be usable in different scanning probe microscope probe based systems.

Optionally, the cassette is mountable in a scanning probe microscope probe based system such that the one or more probe devices can be automatically loaded onto a probe mount of the probe based system and optionally loaded back to the cassette after usage.

The probe cassette may enable safe transportation and storage of the probe devices accommodated therein employing a vacuum-powered clamping fixture. Vacuum (cf. suction) is used for selectively clamping the probe devices to the body of the cassette.

The mounting of the probe device onto a probe mount of the probe based system may be performed in different ways, such as for example by means of vacuum clamping, mechanical clamping, electromagnetic force clamping, electrostatic force clamping and/or adhesive clamping.

Vacuum pressure may be generated outside the cassette by means of an external vacuum source. The cassette may be arranged for maintaining the vacuum provided to the vacuum clamping members for at least a predetermined period of time, even if the vacuum source is disconnected.

Optionally, vacuum is generated internally within the cassette. The cassette may include a vacuum source integrated therein for delivering a vacuum pressure. The vacuum may be generated by using a vacuum pump. The vacuum pump may for instance be connected to an electrical power source. The electrical power source may be external and/or internal (e.g. battery) to the cassette. An internal source of vacuum may provide a more integrated design. An external source of vacuum may be in fluid communication with the cassette via an air tube, or the like, connected to the fluid port of the cassette.

According to an aspect, the invention provides for a use of the probe cassette for storing, transporting and/or handling one or more probe devices for a probe based system.

It will be appreciated that any of the aspects, features and options described in view of the apparatus (probe cassette) apply equally to the use and the described method. It will also be clear that any one or more of the above aspects, features and options can be combined.

### BRIEF DESCRIPTION OF THE DRAWING

The invention will further be elucidated on the basis of exemplary embodiments which are represented in a drawing. The exemplary embodiments are given by way of non-limitative illustration. It is noted that the figures are only schematic representations of embodiments of the invention that are given by way of non-limiting example.

In the drawing:

FIGS. 1A and 1B show in cross section a schematic diagram of an embodiment of a clamping unit of a cassette;

FIG. 2 shows in cross section a schematic diagram of portion of a probe cassette;

FIG. 3 shows a schematic diagram of an embodiment of a clamping unit of a probe cassette;

FIG. 4 shows a schematic diagram of an embodiment of a clamping unit of a probe cassette;

FIG. 5 shows a schematic diagram of an embodiment of a clamping unit of a probe cassette;

FIG. 6 shows a schematic diagram of an embodiment of a clamping unit of a probe cassette;

FIGS. 7A and 7B show a schematic diagram of an embodiment of a clamping unit of a probe cassette;

FIG. 8 shows a schematic diagram of an embodiment of a clamping unit of a probe cassette;

FIG. 9 shows in perspective view a schematic diagram of an embodiment of a cassette;

FIGS. 10A, 10B, 10C and 10D show in cross section a schematic diagram of a clamping unit of a cassette;

FIG. 11 shows a schematic diagram of a process;

FIGS. 12A and 12B show in perspective view a schematic diagram of cassette;

FIG. 13 shows in perspective view a schematic diagram of a probe delivery package and a cassette;

FIGS. 14A and 14B show in perspective view a schematic diagram of a cassette; and

FIGS. 15A and 15B show in cross section a schematic diagram of a cassette at a receptacle.

### DETAILED DESCRIPTION

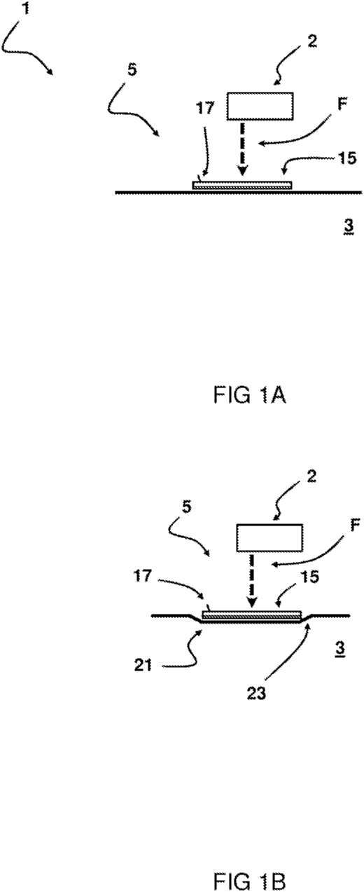

FIGS. 1A and 1B show in cross section a schematic diagram of an embodiment of a clamping unit of a probe cassette. The probe cassette is arranged for storing, transporting and handling one or more probe devices for a probe based system. The cassette including: a cassette body 3 having at least one probe receptacle 5 arranged to accommodate a probe device 15, a lid connectable to the cassette body 3, the lid in a closed position being configured to substantially cover the at least one receptacle 5, and a clamping unit 2 configured to retain the probe device 15 at the receptacle 5 by exerting a clamping force F on said probe device 15 when the lid is in the closed position, wherein the clamping unit 2 includes an adjustment member for adjusting the clamping force F, wherein the clamping unit 2 is selectively operable from a first position, in which the clamping force F is insufficient to provide clamping of the probe device 15 at the receptacle 5, to a plurality of second positions, in which the clamping force F restricts movement of the probe device 15 at the receptacle 5, the plurality of second positions providing different clamping forces F for restricting the probe device at the a different extent. At the plurality of second positions, the clamping force F can be sufficient to an extent at which movement of the probe device 15 at the receptacle 5 is prevented in use. However, the clamping force can be increased in order to achieve better clamping during certain actions or activities, e.g. transportation of the cassette, etc. In this way, it can be better guaranteed that the clamping force is sufficient for successfully clamping the probe device at the receptacle, even when impact forces, vibrations or significant accelerations are applied on the cassette.

In FIGS. 1A and 1B one receptacle 5 is shown in cross section accommodating a probe device 15. Only a portion of the cassette is shown in cross section. The probe device 15 can be selectively clamped in position by means of the clamping unit 2. Different types of probe devices 15 can be held by the cassette at the receptacle 5. In this example, the probe device 15 is a cantilever-based probe device with a probe tip 17. It will be appreciated that the cassette may be arranged to receive other types of probe devices.

A clamping unit 2 is arranged at the probe receptacle 5. The clamping unit 2 is arranged to selectively retain the probe device 15 under an adjustable clamping force induced by the clamping unit 2. The probe cassette may include a plurality of receptacles as depicted in FIGS. 1A and 1B. For example, the probe cassette may include a plurality of arrays/rows of probe receptacles, each array including a plurality of receptacles 5. Each probe receptacle 5 can be configured to receive a probe device. In this example, the probe device 15 is received in the receptacle with tip-up. However, it is also envisaged that the receptacle is adapted to receive the probe devices 15 with tip-down. The probe receptacles can be tailored to accommodate the probe devices 15 and can be positioned closely adjacent to one another to accommodate as many probe devices as possible, thereby improving the packaging efficiency of the probe cassette 1.

In FIG. 1B, a seat 21 is formed at the probe receptacle 5 on the cassette body 3 adapted to the shape and dimensions of the probe device 15. The seat 21 is formed by a lowered/recessed surface 23 on the body 3 of the cassette 1. The seat 21 can be dimensioned such as to facilitate positioning of the probe device 15 at the probe receptacle 5 allowing selective holding of the probe device 15 by means of the clamping unit 2.

The clamping unit 2 may be configured to provide an adjustable pushing force that is strong enough to hold the probe device in place, yet not so great to compromise the integrity of the probe devices. By means of the clamping unit the probe devices can be held against a surface of the body of the probe cassette with an adaptable precision force, yet without damaging the probe device 15. Furthermore, this clamping force F exerted on the probe devices 15 can be accurately controlled using an actuator of the clamping unit 2. Advantageously, the clamping force can be selected depending on the probe device type, shape and/or dimensions. In this way, the probe cassette may be compatible with a wide variety of probe devices.

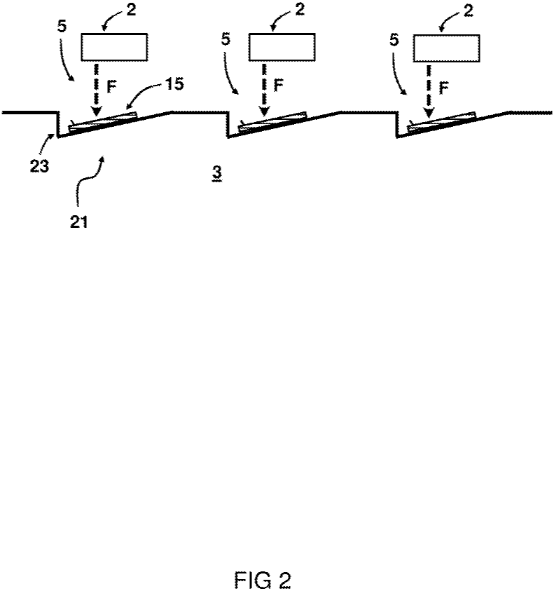

FIG. 2 shows in cross section a schematic diagram of portion of a probe cassette. A plurality of probe receptacles 5 may be arranged next to each other in one or more arrays. Each probe receptacle 5 is adapted to receive a probe device 15. The clamping unit 2 may be adapted to provide an adjustable clamping force F to each probe device 15. The clamping force F may be the same for all the probe devices. However, in an exemplary embodiment, the clamping force F can be separately adjusted for each probe device 15. In this way, a custom clamping force can be provided for each and/or a group of clamping devices 15 held at the receptacles 5 on the cassette body 3 of the cassette.

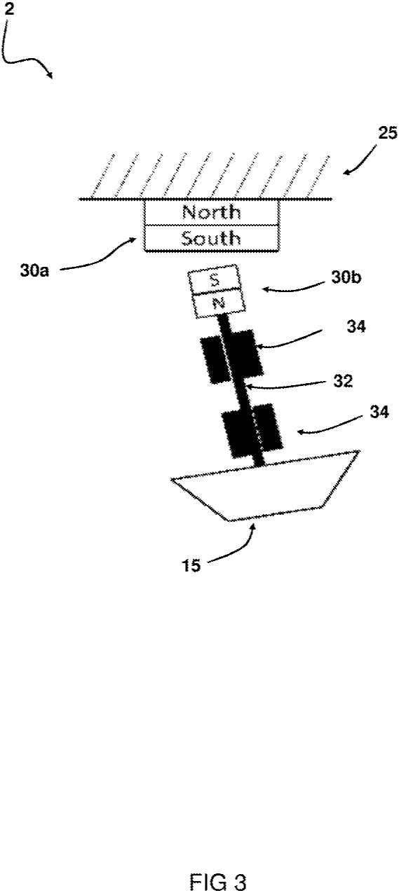

FIG. 3 shows a schematic diagram of an embodiment of a clamping unit 2 of a probe cassette. The clamping unit includes one or more magnets for providing the clamping force F. The cassette includes a lid 25 substantially covering the at least one receptacle 5 in the closed position. As a result of the closing action of the lid 25, the one or more probe devices 15 can be retained on the body 3 of the probe cassette 1 using the magnetic clamping unit 2. The lid 25 in closed position may lock or secure the probe device 15 at the receptacle 5. The cassette may withstand shocks including sudden movements and handling. By means of the adjustable clamping unit 2, the probe devices 15 may provide a selectable clamping force.

The lid 25 may include a first static magnet 30a. A second static magnet 30b can be arranged on an enclosing pin 32. The first magnet 30a is arranged to push an enclosing pin 32 downwards towards the probe device 15 when the lid is closed. This magnetically induced clamping force F can be adjusted by changing a distance between the two static magnets 30a, 30b at a closed position of the lid 25. It is also possible to use electromagnets. In this way, the adjustment of the clamping force F can be performed more accurately. The clamping unit 2 may include one or more optional bearings 34 for guiding the enclosing pin 32.

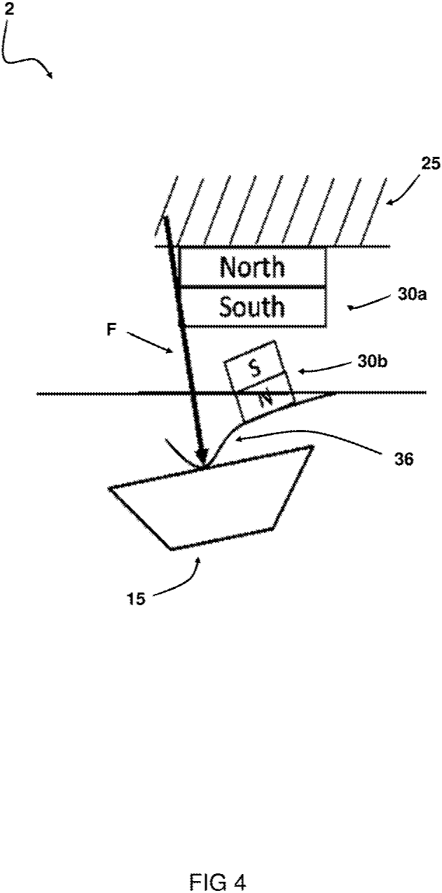

FIG. 4 shows a schematic diagram of an embodiment of a clamping unit 2 of a probe cassette. A first magnet 30a and a second magnet 30b are used (static and/or electromagnets) which approach each other when the lid is closed resulting in a repelling force which is used for generating the clamping force. The clamping unit includes a movable structure 36 arranged to press against probe device when the lid is in the closed position. In this example, the movable structure 36 is bendable. Other types of moving arrangements are also envisaged. In an example, the movable structure 36 is a spring, such as for instance a leaf spring.

A pressing force may be obtained by magnetic force on top of an enclosing sheet metal guiding strip. For example, a static magnet in the lid can keep pressing the enclosing sheet metal guiding strip against its own stiffness downwards on the probe device 15. In an example, the spring is bent >15°, so the sheet metal guiding strip is functioning as a leaf spring pressing with the leaf spring stiffness. In an example, the sheet metal guiding strip is bent < 13° and the magnets are employed, so the strip is only functioning as a guiding & contact element pressed on the probe device by magnetic force. Other advantageous examples are also envisaged.

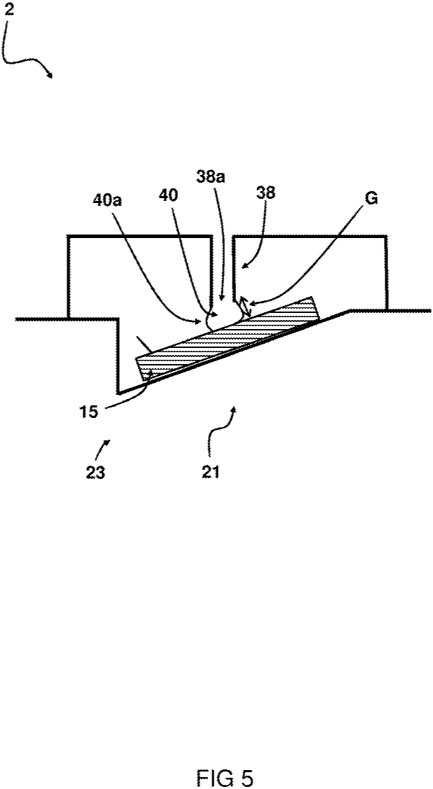

FIG. 5 shows a schematic diagram of an embodiment of a clamping unit 2 of a probe cassette. The clamping unit includes a capillary tube 38 which is configured to guide a liquid 40 towards a surface of the probe device 15 at the receptacle 5 when the lid is in the closed position, wherein the clamping force F is achieved from a resulting surface tension of the liquid 40. The capillary tube 38 is arranged to provide a drop of liquid 40a between its outlet 38a and the probe device 15. The resulting clamping force F obtained by means of the drop of liquid 40a can be dependent on a gap distance G between the outlet of the capillary tube 38 and the probe device 15. This gap distance G may be adjustable in order to enable adjustment of the clamping force. Additionally or alternatively, the clamping force F is adjusted by changing the amount of liquid guided through the outlet 38a of the capillary tube 38.

Fluid can be guided from topside of the probe device by means of the capillary tube 38. Force can be generated by surface tension of extending drop of fluid. It will be appreciated that the drop of fluid can be removed by retracting or evaporation.

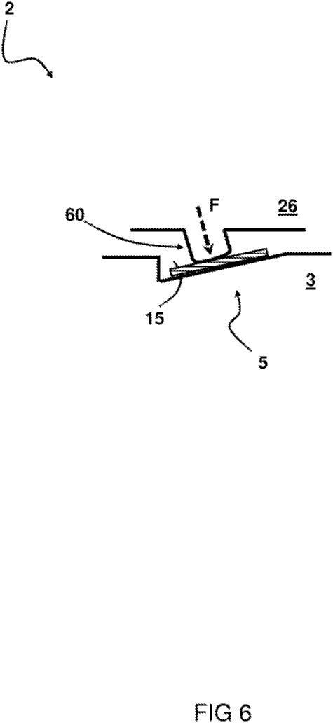

FIG. 6 shows a schematic diagram of an embodiment of a clamping unit 2 of a probe cassette. The clamping unit includes an electromechanical actuator 60 which is configured to selectively provide the clamping force F. The electromechanical actuator is electrically actuated for providing a mechanical clamping of the probe device 15 at the receptacle 5 arranged on the cassette body 3. By adjusting the electrical actuation of the electromechanical actuator 60, an adjustment of the mechanical clamping force F can be obtained.

Different types of electromechanical actuators 60 can be used, such as piezoelectric or elastomer actuators. Advantageously, an accurate control over the clamping force F can be obtained.

A small elastomer element can be used for each probe device. Elastomer foil with pockets/holes can be arranged in an example. A compressive force can be generated by expanding the elastomer using electrical actuation. The elastomer can expand by applying electrical tension. It will be appreciated that such electrical tension can be applied by providing an electric power source to the cassette, e.g. integrating battery in the lid or body of the probe cassette.

In an example, a piezo-element is employed in the lid for each probe device. Actuation of the piezo-element can result in expansion. A piezo sheet can be cut into small elements, facilitating the arrangement of a piezo-element for each probe device. The piezo elements may for example be glued on a PCB powered via the an external power source or a battery for instance arranged in the lid or body of the probe cassette.

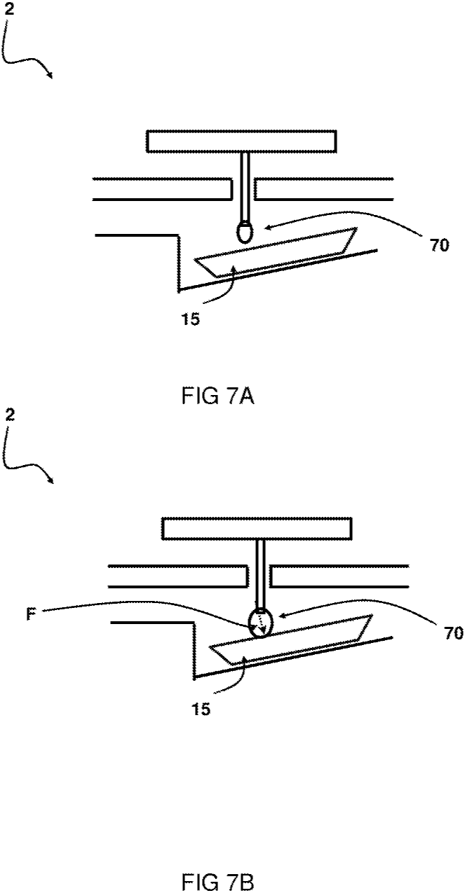

FIGS. 7A and 7B show a schematic diagram of an embodiment of a clamping unit 2 of a probe cassette. The clamping unit 2 includes a membrane expandable under fluid pressure, wherein the membrane in an expanded position contacts the probe device 15 at the receptacle 5 for providing the clamping force F. The membrane can push against a surface of the probe device 15 when in expanded position. As a result of the pushing action, a clamping force is obtained. The clamping force can be adjusted by changing the fluid pressure applied on the membrane. In this embodiment the membrane forms an stretchable balloon 70 arranged proximate the probe device 15 when the lid 25 is in the closed position. The expandable balloon 70 provides an accurate control over the induced clamping force exerted on the probe device. FIG. 7A shows the balloon 70 of the clamping unit 2 in a non-clamping position, and FIG. 7B shows the balloon 70 of the clamping unit 2 in a clamping position in which the inflated/stretched balloon exerts a clamping force on the probe device 15.

Pneumatic actuation with membrane (gas pressure on membrane on top-side) can provide an adequate clamping force for a large variety of probe devices 15. Different types of pushing elements can be arranged on or at the membrane. Membrane can be expanded with gas pressure. However, a liquid pressure (hydraulic actuation) may also be used. It may be more easy to set a maximum air pressure, expanding force or stroke using a gas.

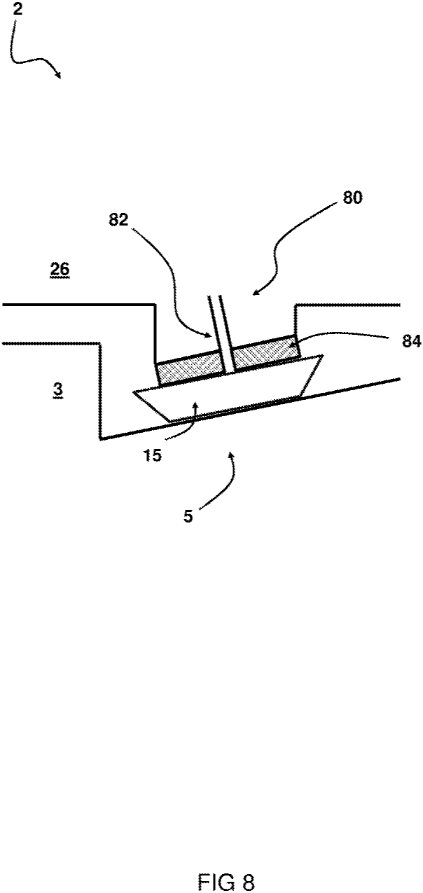

FIG. 8 shows a schematic diagram of an embodiment of a clamping unit 2 of a probe cassette. The clamping unit 2 comprises a fluid blower 80 which is configured to blow a flow of fluid towards the probe device 15 for providing the clamping force F. The fluid flow may provide a sufficient pushing action for holding the probe device fixed at the receptacle. The clamping unit 2 includes a fluid channel 82 arranged to direct fluid under pressure towards a surface of the probe device 15. An optional foam member 84 can be arranged surrounding the fluid channel 82 in order to obtain a more stable clamping force F.

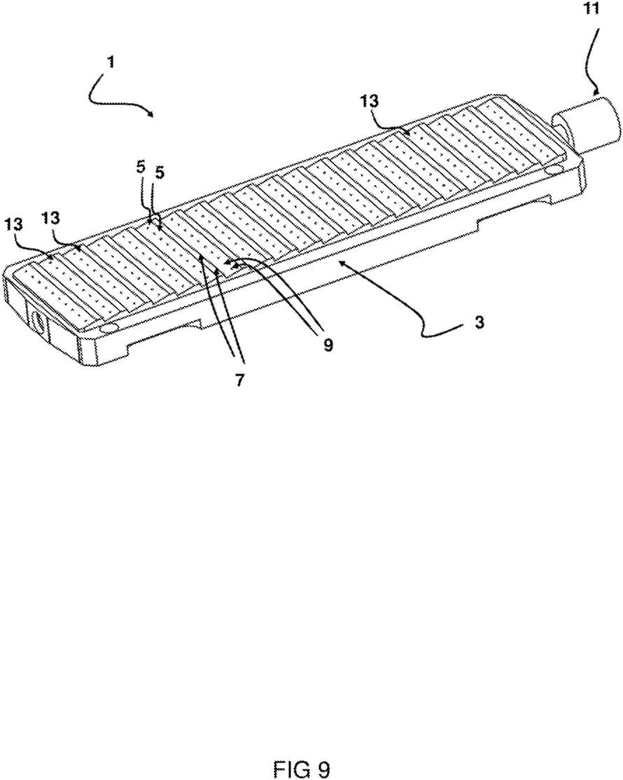

FIG. 9 shows in perspective view a schematic diagram of an embodiment of an exemplary probe cassette 1. The probe cassette 1 is arranged for storing, transporting and handling one or more probe devices (not shown in this figure) for a probe based system, such as a scanning probe microscope. The cassette 1 includes a body 3 having at least one probe receptacle 5 arranged to accommodate a probe device. In this example, at the probe receptacle 5, a vacuum clamping member 7 is arranged for selectively holding the probe device under a clamping force. An aperture 9 is arranged at each receptacle 7. The aperture 9 is arrange at the body of the cassette 1. During selective holding of the probe device, the aperture 9 is connectable to a vacuum pressure through a passageway arranged in the cassette body 3. The cassette 1 includes a first fluid port 11 connectable to a first source of vacuum for delivering the vacuum pressure.

The receptacles 5 may each form a slot adapted to receive a probe device. In this example, the cassette 1 includes a plurality of receptacles 5 arranged in a plurality of arrays 13. Each array 13 has ten receptacles 5 in this exemplary embodiment. Further, the cassette 1 has twenty successive arrays in total arranged next to each other. It will be appreciated that a different number of arrays and/or receptacles is possible. Many configurations are possible. Other types of receptacle arrangements are also possible. For example, one cassette may be arranged to accommodate for more than 100 probe devices, e.g. more than 200 probe devices.

By using the probe cassette 1, individual probe devices can be pre-loaded and transported to a remote location or a probe based system with reduced user intervention. A pre-loaded cassette 1 can be easily shipped in a probe device delivery package. Once delivered, the probe device delivery package and/or the cassette 1 or at least some part thereof can be directly mountable in the probe based system (e.g. AFM). During probe based system operation, the probe devices can then be automatically accessed by the probe based system.

The probe cassette may be interfaced with the probe based system. For example, once the probe cassette 1 is delivered, a lid can be removed or opened. The probe cassette 1 can then be placed in a mounting position of the probe based system, such as on a stage. Alternatively, the probe cassette or probe device delivery package can be introduced to the probe based system and then the lid can be opened within the probe based system. Advantageously, by means of the vacuum clamping members, the probe devices can be retained even when the lid is opened or removed, or further handling with the lid opened or removed. The yield of fully operational probe devices after transportation and handling can thus be improved significantly.

The receptacle 5 may include a support surface on which the probe device can rest, wherein on the support surface at least one vacuum aperture (opening) is arranged for enabling (selective) vacuum clamping. The body of the cassette may include a plurality of apertures (openings), wherein each aperture is arranged for providing vacuum clamping.

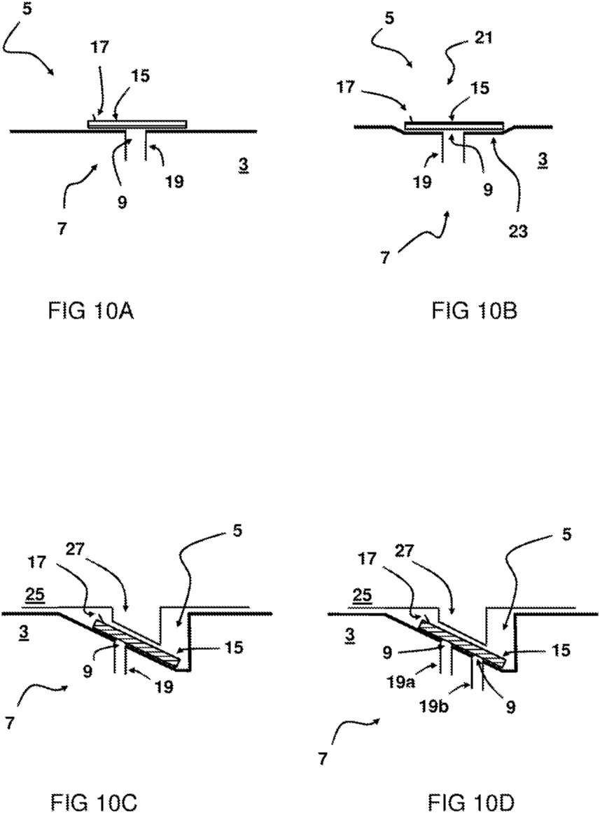

FIGS. 10A, 10B, 10C and 10D show in cross section a schematic diagram of a vacuum clamping member 7 (i.e. further/second clamping unit) of a cassette 1. One receptacle 5 is shown in cross section accommodating a probe device 15. Only a portion of the cassette 1 is shown in cross section. The probe device 15 can be selectively clamped in position by means of the vacuum clamping member 7. In this example, the probe device 15 is a cantilever-based probe device with a probe tip 17. It will be appreciated that the cassette may be arranged to receive other types of probe devices.

A vacuum clamping member 7 is arranged at the probe receptacle 5. The vacuum clamping member 7 is arranged to selectively retain the probe device 15 under a clamping force resulting from vacuum suction selectively induced by the clamping member 7 through an aperture 9. The aperture 9 is arranged on the body of the cassette 1 at the receptacle 7. During said selective retaining of the probe device, the aperture 9 is connectable to a vacuum pressure through a passageway 19 arranged in the cassette body 3. The cassette 1 includes a first fluid port 11 connectable to a first source of vacuum for delivering the vacuum pressure (not shown).

The probe cassette 1 may include a plurality of receptacles as depicted in FIGS. 10A and 10B. For example, the probe cassette 1 may include a plurality of arrays/rows of probe receptacles, each array including a plurality of receptacles 5. Each probe receptacle 5 can be configured to receive a probe device. In this example, the probe device 15 is received in the receptacle with tip-up. However, it is also envisaged that the receptacle is adapted to receive the probe devices 15 with tip-down. The probe receptacles can be tailored to accommodate the probe devices 15 and can be positioned closely adjacent to one another to accommodate as many probe devices as possible, thereby improving the packaging efficiency of the probe cassette 1.

In FIG. 10B, a seat 21 is formed at the probe receptacle 5 adapted to the shape and dimensions of the probe device 15. The seat 21 is formed by a lowered/recessed surface 23 on the body 3 of the cassette 1. The seat can be dimensioned such as to facilitate positioning of the probe device 15 at the probe receptacle 5 allowing selective holding of the probe device 15 by means of the vacuum clamping member.

The vacuum clamping members 7 may be configured to provide a tensile force that is strong enough to hold the probe device in place, yet not so great to compromise the integrity of the probe devices. By means of the vacuum clamping members the probe devices can be held against a surface of the body of the probe cassette with a precision force, yet without damaging the probe device. Furthermore, this tensile force exerted on the probe devices can be accurately adjustable. Optionally, the vacuum force can be selected depending on the probe device type.

FIGS. 10C and 10D show in cross section a schematic diagram of a vacuum clamping member 7 of a cassette 1. A lid 25 is mountable on the probe cassette 1 substantially covering the at least one receptacle 5. The lid 25 may include retaining means (not shown) for retaining the one or more probe devices 15 on the body 3 of the probe cassette 1. The lid 25 in closed position may for instance form-lock the probe device 15 at the receptacle 5. Advantageously, the vacuum clamping member 7 can retain the probe device in position at the probe receptacle 5 using a clamping force induced by vacuum, even when the lid is opened and/or removed. The lid 25 may for instance be opened and/or removed when the cassette is to be placed in the probe based system. Also during these operations the probe device 15 can be kept in position on the body 3 of the cassette 1. In the embodiment of FIG. 10D the clamping member 7 has two apertures 9 and two passageways 19 connected to said respective apertures 9 at the probe receptacle 5. It will be appreciated that other configurations are also possible for achieving vacuum clamping. The body 3 of the cassette 1 includes a slit with an inclined recessed surface adapted to accommodate the probe device 15.

The probe devices 15 can be secured between the lid 25 and the body 3 of the probe cassette 1 when the lid 25 is in a closed positioned. The cassette may withstand shocks including sudden movements and handling. By means of the vacuum clamping member, the probe devices 15 may also be retained even if the lid 25 is removed or opened. It is possible that only a selective vacuum clamping is employed when the lid 25 no longer provides clamping (i.e. opened/removed).

For example, the vacuum-based tensile retaining force securing the probe device 15 to the body 3 of the probe cassette 1 can be sufficiently large such that the probe devices can withstand jostling or jarring during delivery during transport or handling, without comprising the probe device 15 integrity.

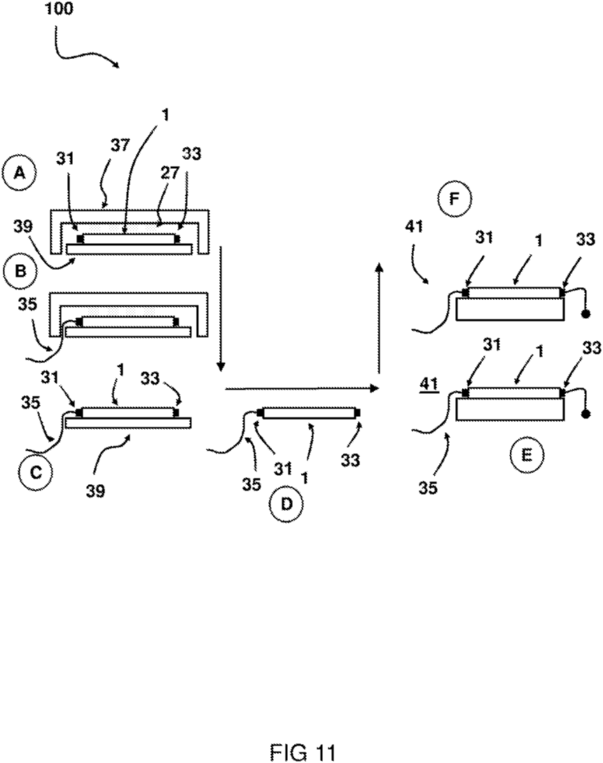

FIG. 11 shows a schematic diagram of a process 100 for delivering probe devices in a probe based system. The probe cassette 1 includes a body having at least one probe receptacle arranged to accommodate a probe device. The probe device is selectively held under a clamping force at the probe receptacle by means of a vacuum clamping member. At the receptacle at least one aperture is provided, which is during selective holding of the probe device connected to a vacuum pressure, through a passageway arranged in the cassette body. The probe cassette is provided with a first fluid port 31 connectable to a first source of vacuum for delivering the vacuum pressure. The fluid connection is achieved by means of a flexible tube 35.

The probe cassette 1 further provided with a second fluid port 33 connectable to a second source of vacuum. The tensile retaining force exerted by means of the vacuum clamping member is adjustable by controlling the vacuum pressure. Furthermore, a lid 37 is mounted on the probe cassette 1 substantially covering the at least one receptacle. Optionally, the lid 37 comprises retaining means 27 for retaining the one or more probe devices on the body of the probe cassette 1. In this example, the cassette 1 is initially housed in a probe cassette delivery package with a base 39 and a lid 37. It will be appreciated that the lid 37 and/or base 39 may be a part of the cassette and/or integrated with the cassette 1.

The probe device(s) can be selectively held in position at the probe receptacle by means of the vacuum clamping member when the lid 37 is to be opened and/or removed. The first fluid port 31 is connectable to the first source of vacuum with the lid 37 being closed.

In the process 100, the first fluid port 31 is connected to the first source of vacuum (step B). The cassette 1, lid 37, base 39 and/or optional package delivery package are arranged for allowing this while the lid 37 is in a closed position. Vacuum is then provided to the cassette 1 enabling the vacuum clamping member to retain the probe devices in position accommodated on the probe cassette 1 by exerting a tensile retaining force. Then, the lid 37 can be removed from the cassette 1 while the probe devices are held in position by means of the vacuum clamping members of the cassette 1 (step C). The probe cassette 1 is then moved to the probe based system with the first fluid port 31 connected to the first source of vacuum providing vacuum (step D). The probe cassette 1 inserted in a chamber 41 of the probe based system is then connected to the second source of vacuum via the second fluid port 33 of the probe cassette 1 (step E). The second source of vacuum is a machine vacuum of the probe based system. The first fluid port 31 is then disconnected from the first source of vacuum (step F). Used probes in the probe based system may be returned to the cassette 1.

The probe based system may be able to selectively access probe devices positioned on the probe cassette. In this regard, one or more selected probe device may be loaded onto one or more probe mounts of the probe based system using means for retrieving/retaining probe devices from the probe cassette. Mechanical clamping, (electro)magnetic clamping, electrostatic force clamping, adhesive clamping and/or vacuum clamping may be employed.

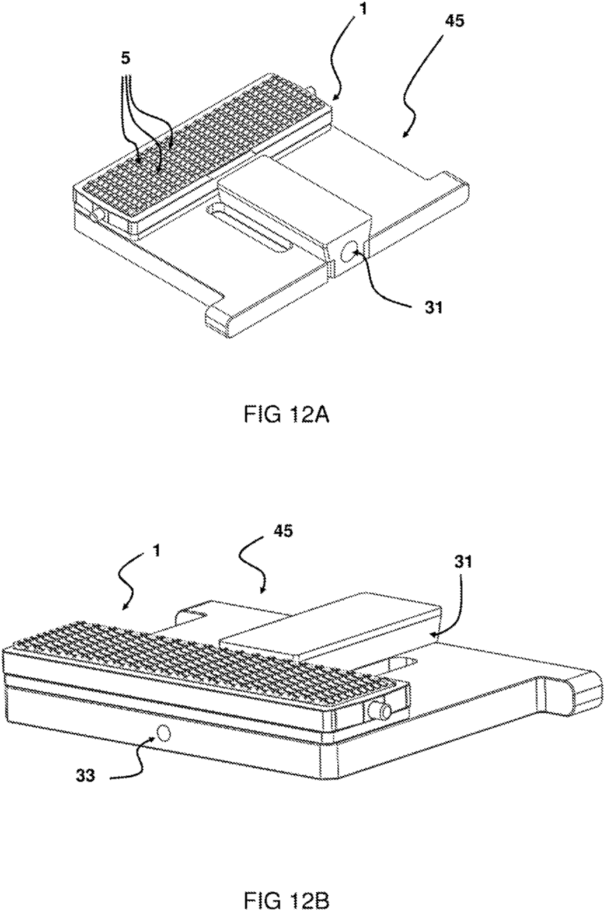

FIGS. 12A and 12B show in perspective view a schematic diagram of cassette 1. In FIG. 12B the view is rotated with respect to the perspective view shown in FIG. 12A. The cassette 1 includes a first fluid port 31 and a second fluid port 33. The fluid ports 31, 33 are arranged in a fluid connection system 45. The probe cassette 1 includes a series of probe vacuum retainers arranged for retaining the probe devices disposed in the probe receptacles 5 of the body of the cassette 1.

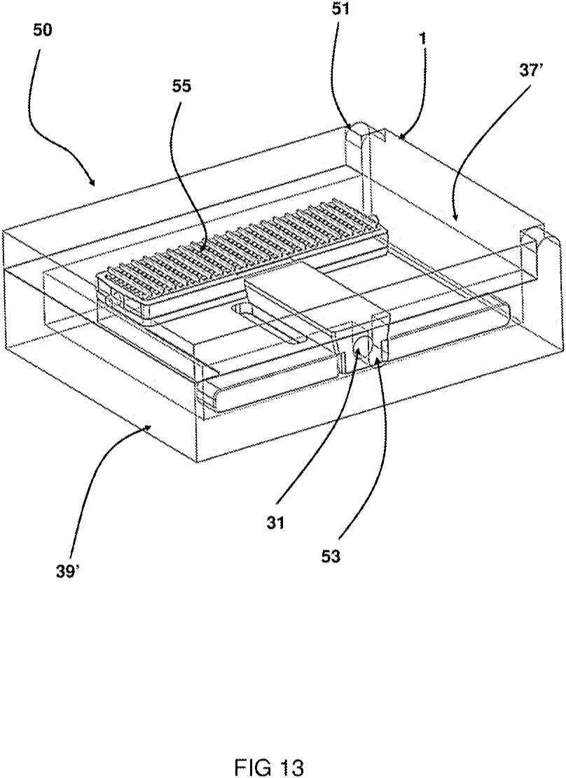

FIG. 13 shows in perspective view a schematic diagram of a probe delivery package 50 and a cassette 1 housed therein. The cassette 1 is arranged to be receivable in the probe device delivery package 50. The probe device delivery package 50 includes a package base 39′ and a package lid 37′ connected with each other. The package lid 37′ is mountable over the body of the cassette 1 so as to substantially cover the at least one receptacle arranged thereon. The first fluid port 31 is connectable to the first source of vacuum with the package lid 37′ in a closed position. The package lid 37′ is movably arranged with respect to the package base 39′ by means of a hinge 51. In this way, the package lid 37′ can be opened up for removal of the cassette 1. In this embodiment, the package base 39′ includes an port opening 53 arranged for allowing fluid connection between the first fluid port 31 of the probe cassette 1 and an external vacuum source while the probe device delivery package 50 is closed (i.e. the package lid 37′ in a closed position). Hence, in this way, the vacuum clamping members of the probe cassette can be selectively operated before the package lid 37′ is opened, resulting in an improved clamping system.

Optionally, the lid includes clamping unit with a series of clampers 55 arranged for interfacing with the probe devices placed in the receptacles 5, wherein a distal edge of the clampers 55 impinge upon the probe devices 15 thereby improving in holding the probe devices in the receptacles. A form lock may be achieved in this way. Optionally, the probe devices are sandwiched between the lid 37′ and the body of the cassette 1. The vacuum clamping members can be operated such as to hold the probe devices within cassette under a clamping force (e.g. tensile/suction force). At the receptacle, a vacuum aperture/opening is arranged for contacting at least a portion of the probe device for retaining the probe device on the base of the cassette when the lid is removed or opened, and/or when the lid is handled without the lid covering the plurality of receptacles (opened/removed position).

By means of the vacuum clamping member, the tensile force exerted on the probe devices can be adjusted. Different tensile forces can be selected. Optionally, the tensile force exerted by means of the tensile vacuum retaining mechanism is variable and can be controlled by means of a controller adjusting the imposed vacuum conditions. A configurable suction force can be exerted on the probe devices for securing said probe devices to the body of the probe cassette 1 during transportation and/or handling of the probe cassette 1.

In some examples, the lid is not be connected to the cassette body, but aligned with and positioned on the cassette body.

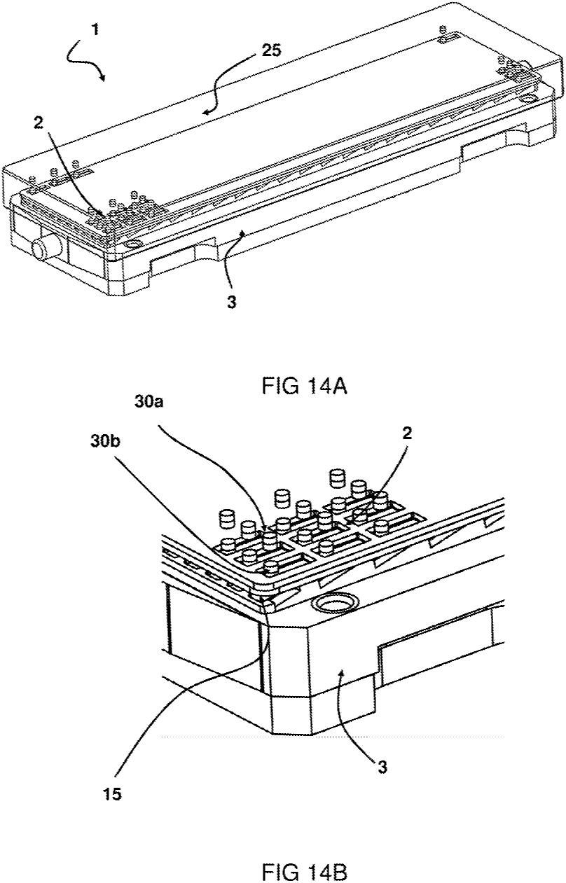

FIGS. 14A and 14B show in perspective view a schematic diagram of a probe cassette 1. The clamping unit 2 includes two magnets for providing the clamping force. In this example, two static/permanent magnets 30a, 30b are arranged. The magnets 30a, 30b are configured such that when the lid is closed the like poles of the magnets 30a, 30b approach each other inducing a required clamping force for retaining the probe devices 15 in position at the receptacle 5 at which it is received. The like poles of the magnets 30a, 30b repel each other, and by changing a gap distance therebetween in the closed position of the lid, the clamping force can be adjusted. The clamping device is adjustable in a plurality of second positions in which the probe device is clamped, each second positions having a different clamping force.

In the shown example, a first magnet 30a and a second magnet 30b are arranged such that like poles of the magnets 30a, 30b are facing each other. The clamping unit 2 is arranged such that the first magnet 30a and second magnet 30b are brought closer to each other when the lid 25 is closed, generating a force used for clamping the probe device 15 at the receptacle 5.

The magnets 30a, 30b are not in contact with each other and are opposed to each other when the lid 25 of the probe cassette 1 is closed. The magnets 30a, 30b interact with each other when the lid 25 is closed, generating a clamping force. Like poles (e.g. N, N or S, S) of each magnet 30a, 30b of the clamping unit 2 face each other. The position of at least one of the two magnets 30a, 30b relative to each other can be adjusted, such that the resulting clamping force is adjustable at least when the lid is closed. Although permanent magnets are employed in this example, it will be appreciated that also the arrangement of electromagnet is envisaged. In the shown example only one clamping unit 2 is shown for one receptacle receiving a single probe device 15. However, a clamping unit 2 may be arranged at each receptacle. It is also envisaged that a plurality of probe devices 15 are received at the receptacle 5.

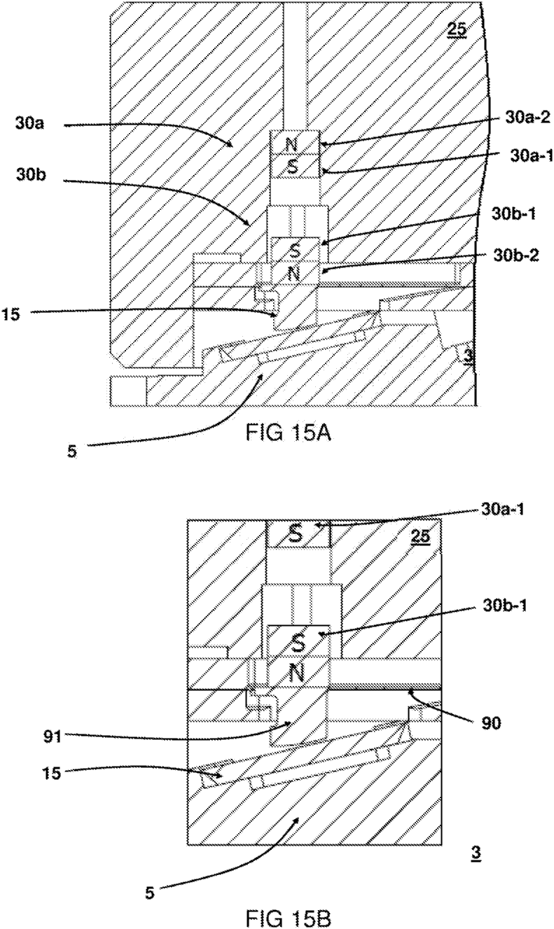

FIGS. 15A and 15B show in cross section a schematic diagram of a cassette at a receptacle. The clamping unit 2 includes a first magnet 30a with magnetic poles 30a-1 and 30a-2 and a second magnet 30b with magnetic poles 30b-1 and 30b-2. Both magnets 30a, 30b are permanent magnets with like poles (30a-1, 30b-1) facing each other for repulsion. The two magnets 30a, 30b are aligned with respect to each other in the shown example. The resulting clamping force is achieved when the lid 25 is closed and/or placed on the body 3 of the probe cassette 1. By adjusting the distance between the two magnets 30a, 30b when the lid is in a closed position, the clamping force can be adjusted. The clamping unit 2 includes an adjustment member for adjusting the clamping force, wherein the clamping unit is selectively operable from a first position, in which the clamping force is insufficient to provide clamping of the probe device 15 at the receptacle 5 (e.g. when lid 25 is open), to a plurality of second positions (e.g. when lid is closed), in which the clamping force restricts movement of the probe device 15 at the receptacle 5, the plurality of second positions providing different clamping forces for restricting the probe device 15 to a different extent.

In the shown example in FIGS. 15A and 15B, the first magnet 30a and second magnet 30b are arranged such that the clamping force for retaining the probe device at the receptacle is based on repulsion force between the two magnets 30a, 30b. The first magnet 30a can be fixed to the lid 25 and the second magnet 30b can be fixed on the guiding member 90. The second magnet 30b can be guided such that a probe clamping pin 91 is pushed the probe device 15. The guiding member 90 can be a guiding flexure. The guiding flexure 90 can be configured to guide the probe clamping pin 91 towards the probe device 15 when the lid 25 of the probe cassette 1 is closed, and to move the probe clamping pin 91 away from the probe device when the lid 25 of the probe cassette is opened or removed from the cassette body 3. It will be appreciated that other structures (e.g. biasing members) may also be used as guiding member 90.

In an exemplary embodiment (not shown), the clamping unit includes a permanent magnets 30a, 30b and at least one electromagnet. A first permanent magnet can be coupled to a further electromagnet to overlay the magnetic field generated between the two permanent magnets. A controller or control unit can be linked to the electromagnet such as to vary the magnetic field and adjust the resulting clamping force.

Optionally, a vacuum hole clamping unit may be arranged for retaining the probe device in position at the receptacle even when the lid 25 is opened or removed from the cassette body 3.

The drawings are not necessarily drawn to scale. Furthermore, in the figures, elements having the same function and structure are given by identical numerals, and a detailed explanation as to these elements will be omitted.

Moreover, all details of the invention may be substituted with other technically equivalent elements and the materials used, as well as the shapes and dimensions of the various components, may vary according to requirements.

The cassette may be usable with many types of probe-based systems. Next to scanning probe microscopes, other probe based systems are also envisaged. It will be appreciated that an atomic force microscope (AFM) can also be used for manipulating portions (e.g. atoms) of a substrate using one or more probe devices. In such a case, the scanning probe microscope may also be called a scanning probe manipulator. The invention may be employable in other machines or systems, for example, machines using fragile units (e.g. substrates, chips) which must be changed periodically. The fragile units may have small dimensions and require a delicate handling (prone to damage if not handled with extreme care). The cassette according to the invention may be employed for transportation and handling of said fragile units.

When a feature or element is herein referred to as being “on” another feature or element, it can be directly on the other feature or element or intervening features and/or elements may also be present. It will also be understood that, when a feature or element is referred to as being “connected”, “attached” or “coupled” to another feature or element, it can be directly connected, attached or coupled to the other feature or element or intervening features or elements may be present.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

“Optional” or “optionally” means that the subsequently described event or circumstance may or may not occur, and that the description includes instances where said event or circumstance occurs and instances where it does not.

In the drawings, which are not necessarily drawn to scale, like numerals may describe similar components in different views. Like numerals having different letter suffixes may represent different instances of similar components.

Various embodiments may be implemented using hardware elements, software elements, or a combination of both. Examples of hardware elements may include processors, microprocessors, circuits, application specific integrated circuits (ASIC), programmable logic devices (PLD), digital signal processors (DSP), field programmable gate array (FPGA), logic gates, registers, semiconductor device, microchips, chip sets, et cetera. Examples of software may include software components, programs, applications, computer programs, application programs, system programs, machine programs, operating system software, mobile apps, middleware, firmware, software modules, routines, subroutines, functions, computer implemented methods, procedures, software interfaces, application program interfaces (API), methods, instruction sets, computing code, computer code, et cetera.

Herein, the invention is described with reference to specific examples of embodiments of the invention. It will, however, be evident that various modifications, variations, alternatives and changes may be made therein, without departing from the essence of the invention. For the purpose of clarity and a concise description features are described herein as part of the same or separate embodiments, however, alternative embodiments having combinations of all or some of the features described in these separate embodiments are also envisaged and understood to fall within the framework of the invention as outlined by the claims. The specifications, figures and examples are, accordingly, to be regarded in an illustrative sense rather than in a restrictive sense. The invention is intended to embrace all alternatives, modifications and variations which fall within the spirit and scope of the appended claims. Further, many of the elements that are described are functional entities that may be implemented as discrete or distributed components or in conjunction with other components, in any suitable combination and location.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A probe cassette for storing, transporting and handling one or more probe devices for a probe based system, the cassette including:
a cassette body having at least one probe receptacle arranged to accommodate a probe device,
a lid connectable to the cassette body, the lid in a closed position being configured to substantially cover the at least one receptacle, and
a clamping unit configured to retain the probe device at the receptacle by exerting a clamping force on said probe device when the lid is in the closed position,
wherein the clamping unit includes an adjustment member for adjusting the clamping force, wherein the clamping unit is selectively operable from a first position, in which the clamping force is insufficient to provide clamping of the probe device at the receptacle, to a plurality of second positions, in which the clamping force restricts movement of the probe device at the receptacle, the plurality of second positions providing different clamping forces for restricting the probe device to a different extent.

2. The probe cassette according to claim 1, wherein the clamping unit includes an actuator which is selectively actuatable from the first position to one of the plurality of the second positions.

3. The probe cassette according to claim 1, wherein the clamping unit includes an electromechanical actuator which is configured to selectively provide the clamping force achieved in the first position and in the plurality of second positions.

4. The probe cassette according to claim 3, wherein the electromechanical actuator is at least one of a piezoelectric actuator or an elastomer actuator.

5. The probe cassette according to claim 1, wherein the clamping unit includes a capillary tube which is configured to guide a liquid towards a surface of the probe device at the receptacle when the lid is in the closed position, wherein the clamping unit is arranged for achieving the clamping force by means of a resulting surface tension of the liquid.

6. The probe cassette according to claim 1, wherein the clamping unit includes one or more magnets for providing the clamping force.

7. The probe cassette according to claim 6, wherein the clamping unit includes at least two opposing magnets having poles arranged to create a repulsive force for providing the clamping force when the lid is closed.

8. The probe cassette according to claim 1, wherein the clamping unit includes a membrane expandable under fluid pressure, wherein, in the plurality of second positions, the clamping unit is configured to bring the membrane in an expanded position in which it contacts the probe device at the receptacle for providing the clamping force.

9. The probe cassette according to claim 8, wherein the membrane forms a stretchable balloon arranged proximate the probe device when the lid is in the closed position.

10. The probe cassette according to claim 1, wherein the clamping unit includes a fluid blower which is configured to blow a flow of fluid towards the probe device for providing the clamping force.

11. The probe cassette according to claim 1, wherein the clamping unit includes a vacuum clamping member which is arranged for selectively holding the probe device under clamping force, wherein at the receptacle at least one aperture is arranged, which is, during selective holding of the probe device, connectable to a vacuum pressure through a passageway arranged in the cassette body.

12. The probe cassette according to claim 1, wherein the clamping unit is a first clamping unit, and wherein the probe cassette includes a further second clamping unit, different from the first clamping unit, wherein the first clamping unit is operable from the first position to one of the plurality of second positions if the lid is closed, wherein the second clamping unit is arranged at the cassette body for selectively holding the probe device at the receptacle under a second clamping force, wherein the second clamping unit is adjustable between a first state, in which the second clamping force is sufficiently large such as to enable clamping of the probe device, and a second state, in which the second clamping force is sufficiently small such as to allow release of the probe device, wherein the second clamping unit is operable when the lid is in an opened position in which the one or more probe devices accommodated in the probe cassette are accessible.

13. The probe cassette according to claim 12, wherein the first clamping unit is arranged at the lid of the cassette probe, and wherein the first clamping unit is automatically operated in one of the plurality of second positions if the lid is brought in the closed position.

14. The probe cassette according to claim 1, wherein the cassette including a controller arranged for controlling the clamping unit for adjusting the clamping force exerted by the clamping unit.

15. A method comprising using a probe cassette for storing, transporting and/or handling one or more probe devices for a probe based system, wherein the cassette includes:
a cassette body having at least one probe receptacle arranged to accommodate a probe device, and
a lid connectable to the cassette body, the lid in a closed position being configured to substantially cover the at least one receptacle,
the method comprising retaining the probe device at the receptacle by exerting a clamping force on said probe device when the lid is in the closed position, and
adjusting the clamping force to selectively operate from a first position, in which the clamping force is insufficient to provide clamping of the probe device at the receptacle, to a plurality of second positions, in which the clamping force restricts movement of the probe device at the receptacle, the plurality of second positions providing different clamping forces for restricting the probe device to a different extent.

16. The probe cassette according to claim 2, wherein the clamping unit is a first clamping unit, and wherein the probe cassette includes a further second clamping unit, different from the first clamping unit, wherein the first clamping unit is operable from the first position to one of the plurality of second positions if the lid is closed, wherein the second clamping unit is arranged at the cassette body for selectively holding the probe device at the receptacle under a second clamping force, wherein the second clamping unit is adjustable between a first state, in which the second clamping force is sufficiently large such as to enable clamping of the probe device, and a second state, in which the second clamping force is sufficiently small such as to allow release of the probe device, wherein the second clamping unit is operable when the lid is in an opened position in which the one or more probe devices accommodated in the probe cassette are accessible.

17. The probe cassette according to claim 5, wherein the clamping unit is a first clamping unit, and wherein the probe cassette includes a further second clamping unit, different from the first clamping unit, wherein the first clamping unit is operable from the first position to one of the plurality of second positions if the lid is closed, wherein the second clamping unit is arranged at the cassette body for selectively holding the probe device at the receptacle under a second clamping force, wherein the second clamping unit is adjustable between a first state, in which the second clamping force is sufficiently large such as to enable clamping of the probe device, and a second state, in which the second clamping force is sufficiently small such as to allow release of the probe device, wherein the second clamping unit is operable when the lid is in an opened position in which the one or more probe devices accommodated in the probe cassette are accessible.

18. The probe cassette according to claim 6, wherein the clamping unit is a first clamping unit, and wherein the probe cassette includes a further second clamping unit, different from the first clamping unit, wherein the first clamping unit is operable from the first position to one of the plurality of second positions if the lid is closed, wherein the second clamping unit is arranged at the cassette body for selectively holding the probe device at the receptacle under a second clamping force, wherein the second clamping unit is adjustable between a first state, in which the second clamping force is sufficiently large such as to enable clamping of the probe device, and a second state, in which the second clamping force is sufficiently small such as to allow release of the probe device, wherein the second clamping unit is operable when the lid is in an opened position in which the one or more probe devices accommodated in the probe cassette are accessible.

19. The probe cassette according to claim 8, wherein the clamping unit is a first clamping unit, and wherein the probe cassette includes a further second clamping unit, different from the first clamping unit, wherein the first clamping unit is operable from the first position to one of the plurality of second positions if the lid is closed, wherein the second clamping unit is arranged at the cassette body for selectively holding the probe device at the receptacle under a second clamping force, wherein the second clamping unit is adjustable between a first state, in which the second clamping force is sufficiently large such as to enable clamping of the probe device, and a second state, in which the second clamping force is sufficiently small such as to allow release of the probe device, wherein the second clamping unit is operable when the lid is in an opened position in which the one or more probe devices accommodated in the probe cassette are accessible.

20. The probe cassette according to claim 11, wherein the clamping unit is a first clamping unit, and wherein the probe cassette includes a further second clamping unit, different from the first clamping unit, wherein the first clamping unit is operable from the first position to one of the plurality of second positions if the lid is closed, wherein the second clamping unit is arranged at the cassette body for selectively holding the probe device at the receptacle under a second clamping force, wherein the second clamping unit is adjustable between a first state, in which the second clamping force is sufficiently large such as to enable clamping of the probe device, and a second state, in which the second clamping force is sufficiently small such as to allow release of the probe device, wherein the second clamping unit is operable when the lid is in an opened position in which the one or more probe devices accommodated in the probe cassette are accessible.
